(19) United States
(12) Patent Application Publication
(10) Pub. No.: US 2020/0092656 A1
(43) Pub. Date: Mar. 19, 2020

(54) Piezoelectric Audio System

(71) Applicant: Arlmone R. Smith, Pueblo, CO (US)

(72) Inventor: Arlmone R. Smith, Pueblo, CO (US)

(21) Appl. No.: 16/570,885

(22) Filed: Sep. 13, 2019

Related U.S. Application Data
(60) Provisional application No. 62/733,234, filed on Sep. 19, 2018.

(51) Int. Cl. H04R 17/00; H04R 7/06; H04R 1/08

(52) U.S. Cl. CPC H04R 17/00; H04R 2499/11; H04R 1/08; H04R 7/06

(57) ABSTRACT

In general, a piezoelectric audio system removably mountable to an acoustic resonator. Specifically, a piezoelectric audio system utilizing piezoelectric layers engageable with an acoustic resonator to generate an audio output.

This United States Non-Provisional patent application claims the benefit of U.S. Provisional Patent Application No. 62/733,234, filed Sep. 19, 2018, hereby incorporated by reference herein.

### I. FIELD OF THE INVENTION

In general, a piezoelectric audio system removably mountable to an acoustic resonator. Specifically, a piezoelectric audio system utilizing piezoelectric layers engageable with an acoustic resonator to generate an audio output.

### II. SUMMARY OF THE INVENTION

A broad object of particular embodiments of the invention can be to provide an audio system including an audio generator including a first plate, a second plate, and a spacer interconnecting the first plate and the second plate in fixed spaced apart relation to provide an open space between the first and second plate inner faces which extends from the spacer to the corresponding first and second plate edges, and a first piezoelectric layer coupled to the first plate outer face, and a second piezoelectric layer coupled to the second plate outer face, where the first and second piezoelectric layers can correspondingly engage a first acoustic resonator or a second acoustic resonator, whereby operation of the first or second piezoelectric layer at a resonance frequency can correspondingly resonate the first or second acoustic resonator to generate an audio output.

Another broad object of particular embodiments of the invention can be a method of making an audio system including one or more of interconnecting a first plate and a second plate in fixed spaced apart relation with a spacer to provide an open space between the first and second plate inner faces extending from the spacer to the corresponding first and second plate edges, correspondingly coupling a first piezoelectric layer to the first plate outer face, and coupling a second piezoelectric layer to the second plate outer face, wherein the first and second piezoelectric layer adapted to correspondingly engage a first acoustic resonator or a second acoustic resonator, whereby operation of the first or second piezoelectric layer at a resonance frequency can correspondingly resonate the first or second acoustic resonator to generate an audio output.

Another broad object of particular embodiments of the invention can be to provide a method of using an audio system including one or more of engaging first or second piezoelectric layers disposed on outwardly facing first and second plate outer faces with first or second acoustic resonators, transmitting digitized audio data to the audio system, processing the digitized audio data by executing an audio processing program, generating an electrical field which varies in amplitude or frequency based upon processing of the digitized audio data, driving the first or second piezoelectric layer at a resonance frequency, and transferring the resonance frequency to the first or second acoustic resonator to produce an audio output.

Naturally, further objects of the invention are disclosed throughout other areas of the specification, drawings, photographs, and claims.

### III. BRIEF DESCRIPTION OF THE DRAWINGS

FIG. 1 is a schematic diagram showing a particular embodiment of a piezoelectric audio system.

FIG. 2 is a perspective view of a particular embodiment of a piezoelectric audio system.

FIG. 3 is a top plan view of a particular embodiment of a piezoelectric audio system.

FIG. 4 is a bottom plan view of a particular embodiment of a piezoelectric audio system.

FIG. 5 is a first side elevation view of a particular embodiment of a piezoelectric audio system.

FIG. 6 is a second side elevation view of a particular embodiment of a piezoelectric audio system.

FIG. 7 is a front elevation view of a particular embodiment of a piezoelectric audio system.

FIG. 8 is a back elevation of a particular embodiment of a piezoelectric audio system.

FIG. 9 is a perspective view of a particular method of mounting a piezoelectric audio system.

FIG. 10 is a top plan view of a second particular embodiment of a piezoelectric audio system.

FIG. 11 is a bottom plan view of a second particular embodiment of a piezoelectric audio system.

FIG. 12 is a first side elevation view of a second particular embodiment of a piezoelectric audio system.

FIG. 13 is a second side elevation view of a second particular embodiment of a piezoelectric audio system.

FIG. 14 is a front elevation view of a second particular embodiment of a piezoelectric audio system.

FIG. 15 is a back elevation view of a second particular embodiment of a piezoelectric audio system.

FIG. 16 is a top plan view of a particular embodiment of a mounting plate.

FIG. 17 is a bottom plan view of a particular embodiment of a mounting plate.

FIG. 18 is a first side elevation view of a particular embodiment of a mounting plate.

FIG. 19 is a second side elevation view of a particular embodiment of a mounting plate.

FIG. 20 is a front side elevation view of a particular embodiment of a mounting plate.

FIG. 21 is a back side elevation view of a particular embodiment of a mounting plate.

FIG. 22 is a perspective view of a particular method of using a piezoelectric audio system.

FIG. 23 is a top plan view of a particular embodiment of a piezoelectric audio system showing portions of the interior of the piezoelectric audio system.

### IV. DETAILED DESCRIPTION OF THE INVENTION

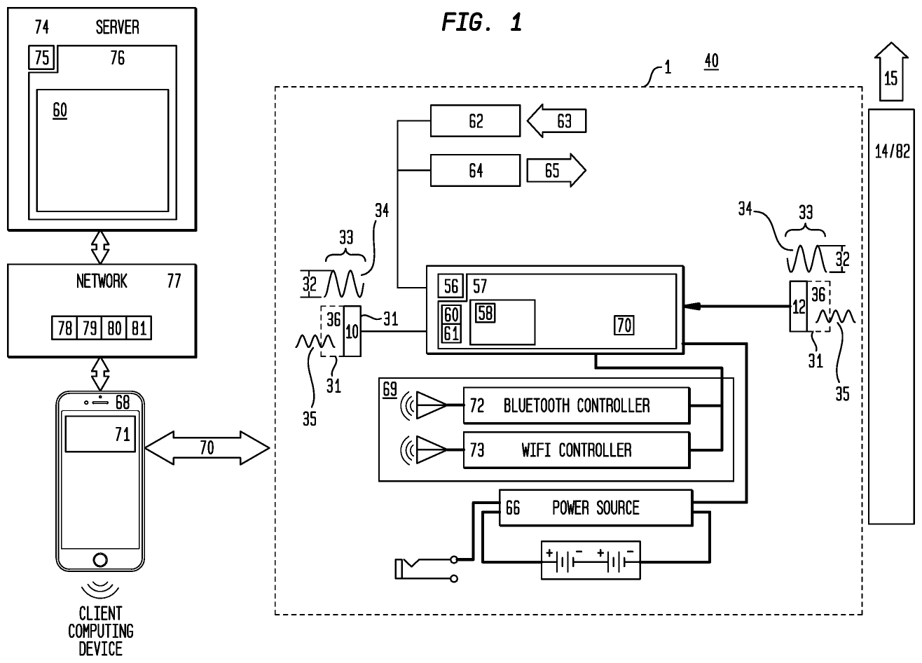

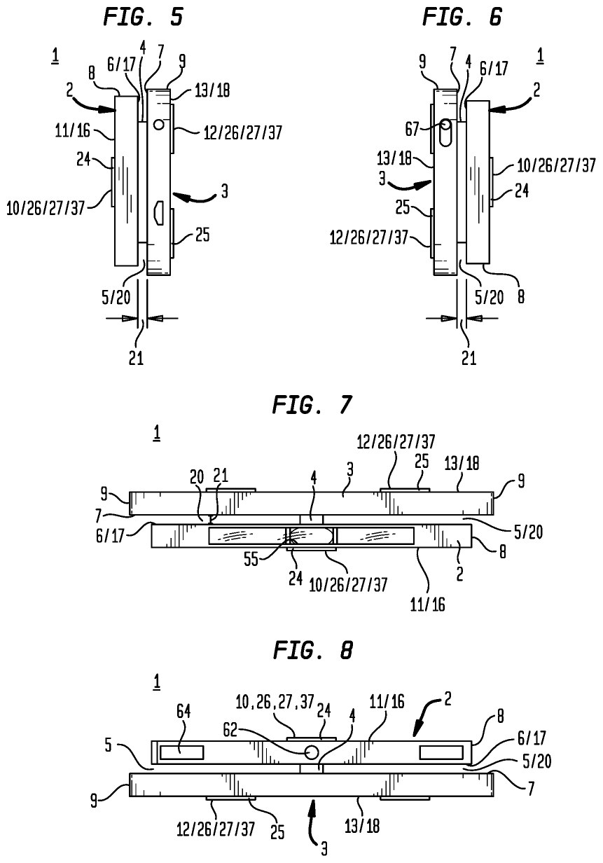

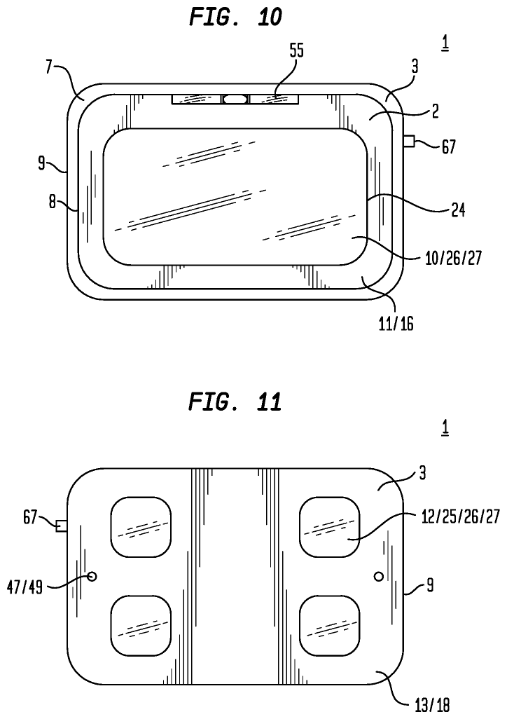

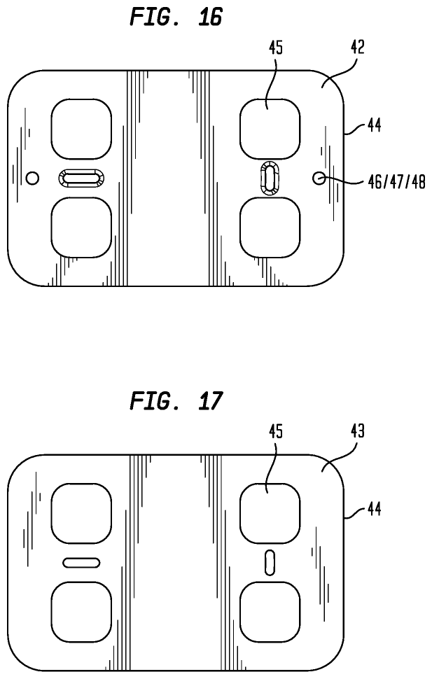

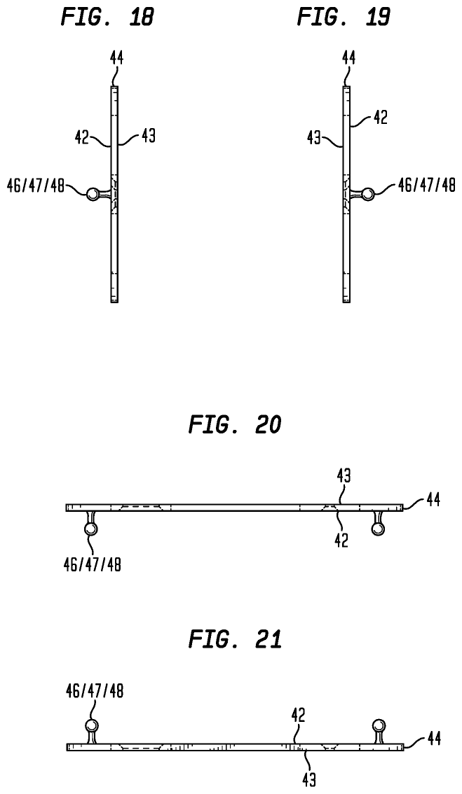

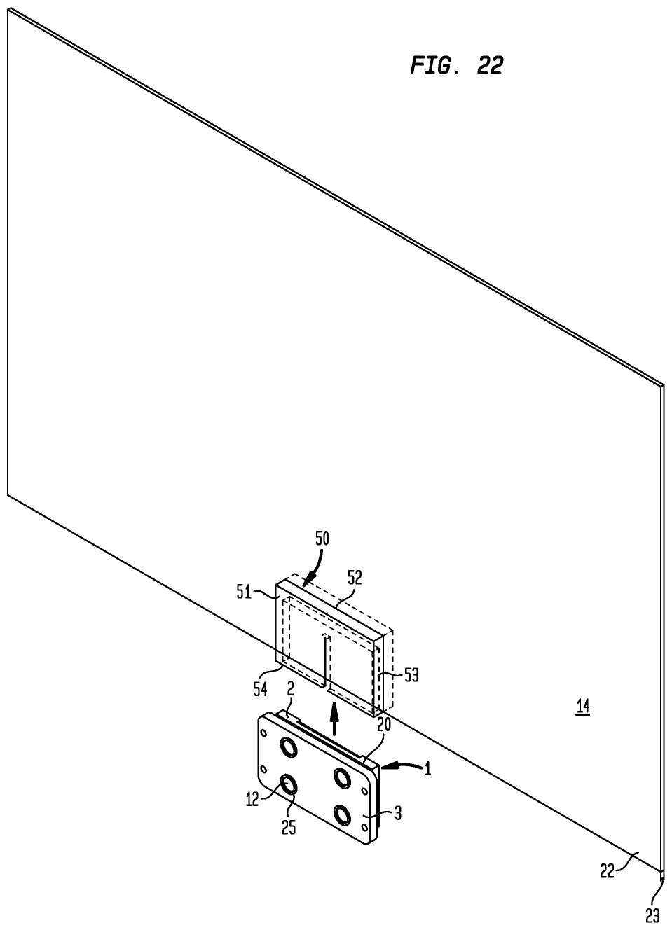

Generally referring to FIGS. 1 through 23, particular embodiments of an audio system (40) can include one or more of: an audio generator (1) including a first plate (2), a second plate (3), a spacer (4) interconnecting the first plate (2) and the second plate (3) in fixed spaced apart relation to provide an open space (5) between first and second plate inner faces (6)(7) which extends from the spacer (4) to corresponding first and second plate edges (8)(9), a first piezoelectric layer (10) coupled to the first plate outer face (11) and a second piezoelectric layer (12) coupled to a second plate outer face (13). The first or second piezoelectric layer (10)(12) can be engaged to an acoustic resonator (14) to generate an audio output (15).

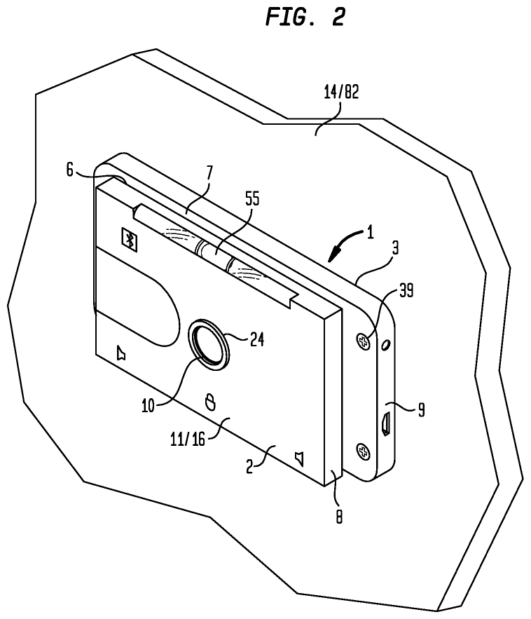

Now, with primary reference to FIGS. 2 through 8 and 10 through 15, in particular embodiments, the first plate (2) can have a first plate outer face (11) disposed opposite a first plate inner face (6). Both the first plate outer face (11) and first plate inner face (6) can extend to first plate edges (8). The first plate edges (8) can delimit a first plate outer face area (16) and first plate inner face area (17) which can, but need not necessarily be configured as: a polygon such as a triangle, a square, a rectangle, a pentagon, a hexagon; an ellipse, a circle, or other configuration which can support a first piezoelectric layer (10) on the first plate outer face (11). While the first plate outer face (11) and the first plate inner face (6) are depicted as being planar or generally planar; these illustrative examples are not intended to preclude a first plate outer face (11) or a first plate inner face (6) having a non-planar configuration to mateably engage a corresponding non-planar acoustic resonator (14).

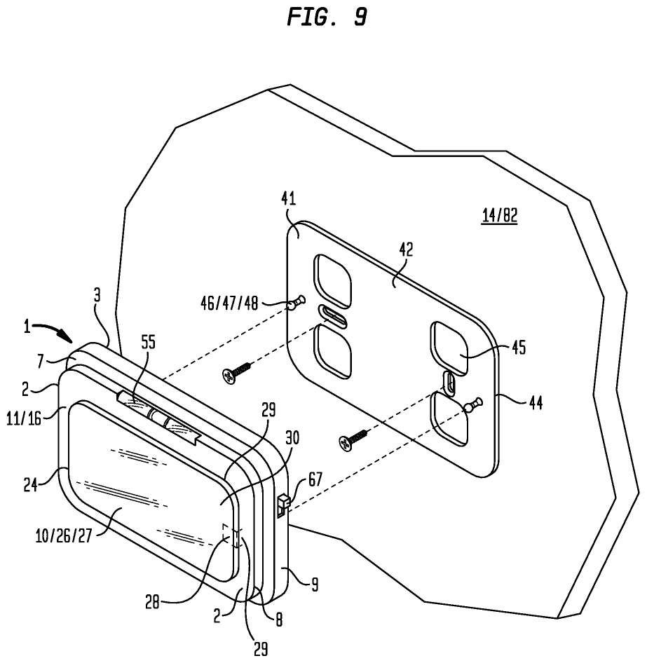

Again, with primary reference to FIGS. 2 through 8 and 10 through 15, the second plate (3) can have a second plate outer face (13) disposed opposite a second plate inner face (7). Both the second plate outer face (13) and the second plate inner face (7) can extend to second plate edges (9). The second plate edges (9) can delimit the second plate outer face area (18) and second plate inner face area (19) which can, but need not necessarily be configured as: a polygon such as a triangle, a square, a rectangle, a pentagon, a hexagon; an ellipse, a circle, or other configuration which can support a second piezoelectric layer (12) on the first plate outer face (11). While the second plate outer face (13) and the second plate inner face (7) are depicted as being planar or generally planar; these illustrative examples are not intended to preclude a second plate outer face (13) or a second plate inner face (7) having a non-planar configuration to mateably engage a corresponding non-planar acoustic resonator (14). In particular embodiments, the first plate (2) can be congruent or substantially congruent to the second plate (3) (as shown in the illustrative example of FIGS. 9 through 15). In other particular embodiments, the first plate (2) and the second plate (3) can have different configurations in regard to the areas delimited by the first plate edges (8) and the second plate edges (9) (as shown in the illustrative example of FIGS. 2 through 8).

Again, with primary reference to FIGS. 2 through 8 and 10 through 15, in particular embodiments, the spacer (4) can interconnect the first plate inner face (6) and the second plate inner face (7) in fixed spaced apart relation. Interconnection of the first plate inner face (6) and second plate inner face (7) by the spacer (4) can provide an open space (5) between the first and second plate inner faces (6)(7). The open space (5) can extend from the spacer (4) to the corresponding first and second plate edges (8)(9). In particular embodiments, the open space (5) between the first and second plate (2)(3) can define a slot (20) having a width (21). The width (21) of the slot (20) can permit an object (22) or a portion of an object (22) having a substantially similar width (23) or lesser width (23) to be disposed within the slot (20).

Again, with primary reference to FIGS. 2 through 8 and 10 through 15, in particular embodiments a first piezoelectric layer (10) and a second piezoelectric layer (12) can be correspondingly coupled to the first plate outer face (11) and second plate outer face (13); although, this does not preclude embodiments which include only a first or second piezoelectric layer (12) coupled to a first plate outer face (11) or a second plate outer face (13).

In particular embodiments, the first piezoelectric layer (10) can continuously extend over the first plate outer face (11) or the second plate outer face (13) to corresponding first or second piezoelectric layer peripheries (24)(25) disposed at, proximate or a distance from the first plate edges (8) (as shown in the illustrative examples of FIGS. 9 through 15). In these particular embodiments, the first piezoelectric layer (10) or the second piezoelectric layer (12) can be configured as a substantially flat piezoelectric plate (26) or piezoelectric film (27). In particular embodiments, the piezoelectric plate (26) or piezoelectric film (27) can have a dimensional range in the length or width of about 1 millimeter to about 165 millimeters and a thickness of about 0.08 millimeters to about 48 millimeters with incremental embodiments within the range pertaining to the length or width of about 1 millimeter and pertaining to the thickness of about 0.05 millimeters.

With reference to the first piezoelectric layer (10) but, understanding that the following description also applies to the second piezoelectric layer (12), piezoelectric electrodes (28) can be applied to the positive and negative surfaces (29)(30) of the first piezoelectric layer (10). The static dimension (31) of the first piezoelectric layer (10) can vary based on the amplitude (32) and frequency (33) of an electric field (34) applied to the first piezoelectric layer (10). The variation of the amplitude (32) and frequency (33) of the electric field (34) applied to the first piezoelectric layer (10) can cause the static dimension (31) of the first piezoelectric layer (10) to change cyclically at the cycling frequency of the electric field (34) converting electrical energy into mechanical energy or resonance frequency (35). The elastic deformation (36) of the first piezoelectric layer (10) can elastically deform (36) based on the amplitude (32) and frequency (33) of the electric field (34) applied to the first piezoelectric layer (10) and generate a resonance frequency (35) in association with an acoustic resonator (14). Depending on the piezoelectric material and configuration of the piezoelectric layer (10), a wide range of resonance frequency (35) can be generated in the first piezoelectric layer (10) or the acoustic resonator (14) coupled to the first piezoelectric layer (10) to generate an audio output (15) having a frequency within the range of human hearing of about 20 Hz to about 20,000 Hz. The piezoelectric material of the first or second piezoelectric layer (10)(12) can comprise or be selected from the group consisting of: piezoelectric ceramics, piezocomposites, quartz, Rochelle salt, topaz, tourmaline-group minerals, polyvinylidene difluoride, barium titanate, lead titanate, lead zirconate titanate, potassium niobite, lithium niobite, lithium tantalate, and combinations thereof. In particular embodiments, the first or second piezoelectric material can be obtained from Solvay Specialty Polymers, such as Solvene® 200, Solvene® 250, and Solvene® 3000 (VDF-TRFE).

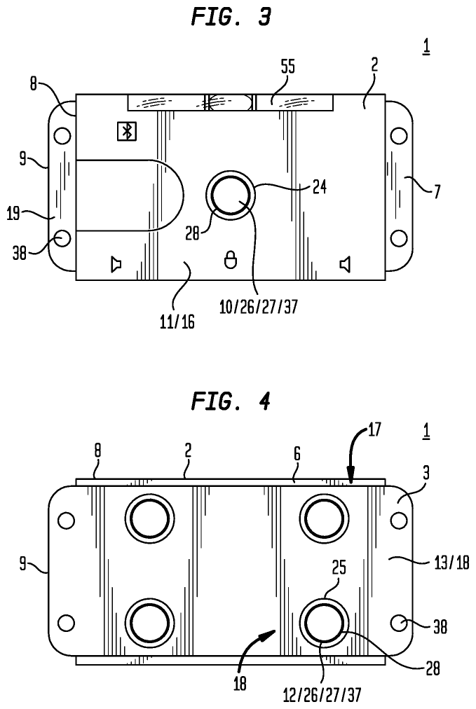

In particular embodiments, the first piezoelectric layer (10) or second piezoelectric layer (12) can, but need not necessarily, include a plurality of first or second piezoelectric layers (10)(12) coupled in spaced apart relation to the first plate outer face (11) or the second plate outer face (13). As depicted in the illustrative examples, of FIGS. 4 through 8 and 11 through 15, the configuration of the first or second piezoelectric layer (10)(12) can include a plurality of piezoelectric discs (37)(or piezoelectric rings) coupled to the first or second plate outer face (11)(13) in spaced apart relation; although the illustrative description of piezoelectric plates, films, discs or rings is not intended to preclude embodiments including piezoelectric materials in other configurations, such as tubes, hemispheres, or staves.

Now, with primary reference to FIGS. 2, 9 and 22, in particular embodiments, an acoustic resonator (14) can be engaged to either the first piezoelectric layer (10) or the second piezoelectric layer (12). The acoustic resonator (14) can include any object, whether in whole or in part, which can be engaged to the first piezoelectric layer (10) or second piezoelectric layer (12) capable of resonance in response to the resonance frequency (35) of the first piezoelectric layer (10) or second piezoelectric layer (12) to produce an audio output (15). In particular embodiments, the acoustic resonator (14) can amplify the resonance frequency (35) of the first piezoelectric layer (10) or the second piezoelectric layer (12) to allow the audio output (15) to be amplified within a range of about −15 decibels to about 85 decibels (within normal hearing range for humans); although, this description is not intended to preclude embodiments of audio output (15) having applications outside of the normal hearing range of humans, as illustrative examples, for use as non-invasive sound wave treatment in the ultrasound range, or for use with animals such as dogs or cats above 20,000 Hz (or between about 20,000 Hz and 45,000 Hz); although audio output (15) having a frequency of less 20 Hz and greater than 20,000 HZ can be produced. Acoustic resonators (14) suitable for use with embodiments of the invention can include, but are not limited to, in whole or in part, exterior and interior walls of buildings (including but not limited to drywall construction), flooring, ceilings, exterior decks; furniture such as tables, desks, cabinets, book shelves; objects such as display screens, picture frames; and sheet materials such as, drywall, plywood, chipboard, fiberboard, plastic such as acrylic, acrylonitrile butadiene styrene, polyethylene, polypropylene; and metal such as aluminum, iron, brass, copper, tin, and combinations thereof.

Now, with primary reference to FIG. 2, the second plate (3) can further include one or more mounting apertures (38) communicating between the second plate inner and outer face (7)(13). The second plate outer face (13) can engage an acoustic resonator (14) and a mounting fastener (39) can be disposed in the one or more mounting apertures (38) and fasten the second plate (3) to the acoustic resonator (14) and concurrently engage the second piezoelectric layer (12) with the acoustic resonator (14).

Now, with primary reference to FIGS. 9 and 16 through 21, particular embodiments of the audio system (40) can, but need not necessarily, further include an audio system mounting plate (41) (or mounting plate) configured to fixedly or releasably interconnect the first plate (2) to an acoustic resonator (14). The mounting plate (41) can have a mounting plate first side (42) opposite a mounting plate second side (43). The mounting plate first side (42) and the mounting plate second side (43) can extend to mounting plate edges (44). The mounting plate first side (42) can be configured to removably secure to the second plate outer face (13). The mounting plate second side (43) can be configured to engage an acoustic resonator (14). In particular embodiments, the mounting plate (41) can further include one or more mounting plate apertures (45). The mounting plate apertures (45) can communicate between the mounting plate first side (42) and the mounting plate second side (43). The mounting plate aperture (45) can be configured to permit the second piezoelectric layer(s) (12) to pass through the corresponding mounting plate aperture(s) (45) and contact the acoustic resonator (14).

Now, with primary reference to FIGS. 9 and 16 through 21, particular embodiments of the mounting plate (41) can further include one or more securement elements (46). The securement element(s) (46) can be disposed on the mounting plate first side (42) or the second plate outer face (13). The securement element (46) can fixedly or releasably secure the second plate outer face (13) to the mounting plate first side (42). In particular embodiments, the one or more securement elements (46) can include mateable fastener pair(s) (47). The mateable fastener pair (47) can mateably engage to fixedly or releasably secure the second plate (3) to the mounting plate first side (42). In particular embodiments, the mateable fastener pair (47) can include a pair of posts (48). The pair of posts (48) can be disposed on the mounting plate first side (42) or the second plate outer face (13). A corresponding pair of post receptacles (49) can be disposed on the mounting plate first side (42) if the pair of posts (48) are disposed on the second plate outer face (13), or the second plate outer face (13) if the pair of posts (48) are disposed on the mounting plate first side (42). The pair of post receptacles (49) can be configured to mateably engage the pair of posts (48) to fixedly or releasably secure the second plate outer face (13) to the mounting plate first side (42) by interference fit or snap fit.

Now, with primary reference to FIG. 22, particular embodiments of the audio system (40) can, but need not necessarily, further include an acoustic resonator mount (50) configured to fixedly or releasably interconnect the second plate (3) to an acoustic resonator (14). The acoustic resonator mount (50) can have a mount first side (51) opposite a mount second side (52). The mount first side (51) and the mount second side (52) can extend to mount edges (53) which dispose the mount first side (51) and the mount second side (52) in spaced apart relation to define a mount interior space (54) configured to receive the second plate (3) with the mount first side (51) disposed in the open space (5) between the first and second plate inner faces (6)(7). The mount second side (52) can engage the second piezoelectric layer (12) disposed on the second plate outer face (13) to provide the acoustic resonator (14) or be configured to engage a discrete acoustic resonator (14). In particular embodiments, the acoustic resonator (14) and the acoustic resonator mount (50) can comprise a one-piece construct. In particular embodiments, the acoustic resonator (14) which couples to, directly couples to, or comprises one-piece with the acoustic resonator mount (50) can comprise a piece of sheet material, an electronic display screen, a picture frame, or other object.

Now, with primary reference to FIGS. 2 and 9, particular embodiments of the audio system (40) can further include a level (55). The level (55) can be disposed on the first plate (2) or the second plate (3). In particular embodiments, the level (55) can be a bubble level (also referred to as a spirit level), or other device disposed on the first plate (2) or the second plate (3) adapted to indicate whether or not the audio system (40) has been disposed horizontally.

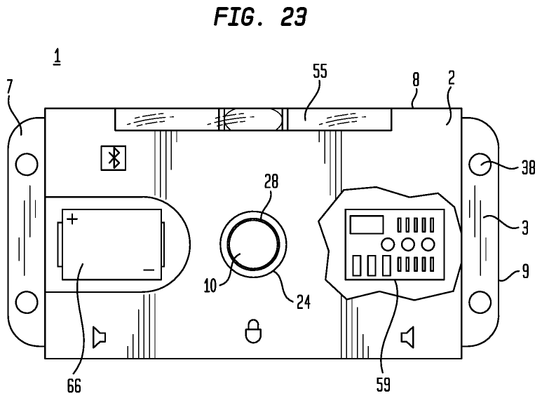

Now, with primary reference to FIGS. 1 and 23, particular embodiments of the audio system (40) can further include a processor (56). The processor (56) can be communicatively coupled to a non-transitory memory element (57). The non-transitory memory element (57) can include an audio processing program (58). The audio processing program (58) can be executable to control an audio processing circuit (59). The audio processing circuit (59) can receive digitized audio data (60), convert the digitized audio data (60) to audio amplitude and frequency data (61), generate an electric field (34) having an amplitude (32) and frequency (33) which varies based on the audio amplitude and frequency data (61), and apply the electric field (34) having an amplitude (32) and a frequency (33) to either the first piezoelectric layer (10) or the second piezoelectric layer (12).

Now, with primary reference to FIGS. 1, 8 and 15, particular embodiments of the audio system (40) can further include a microphone (62). The microphone (62) can be disposed on the first plate (2) or the second plate (3). The microphone (62) can be communicatively coupled to the audio processing circuit (59). In particular embodiments, the audio processing program (58) can be further executable to receive a microphone analog input (63) from the microphone (62), convert the microphone analog input (63) to audio amplitude and frequency data (61), generate an electric field (34) having an amplitude (32) and frequency (33) which varies based on the audio amplitude and frequency data (61), and apply the electric field (34) having an amplitude (32) and frequency (33) to the first piezoelectric layer (10) or the second piezoelectric layer (12).

Now, with primary reference to FIGS. 1, 8 and 15, particular embodiments of the audio system (40) can further include a speaker (64). The speaker (64) can be disposed on the first plate (2) or the second plate (3). The speaker (64) can be communicatively coupled to the audio processing circuit (59). In particular embodiments, the audio processing program (58) can be further executable to receive a digitized audio data (60) or microphone analog input (63), convert the digitized audio data (60) or microphone analog input (63) to an audio amplitude and frequency data (61), generate an electric field (34) having an amplitude (32) and frequency (33) which varies based on the audio amplitude and frequency data (61), and apply the electric field (34) to the speaker (64) to generate speaker audio output (65).

Now referring to FIGS. 1 through 9 and 10 through 15, particular embodiments of the audio system (40) can further include a power source (66). The power source (66) can be electrically coupled to the audio processing circuit (59). The power source (66) can be any source of energy which can be converted into electricity, including as illustrative examples, one or more of: an electric battery such as an alkaline battery, lithium ion battery, nickel metal hydride battery or the like, alternating current supply, or the like along with the associated circuitry to convert the electrical power to voltage and amperes consistent with the operation of the processor. In particular embodiments, the power source (66) can be disposed on either the first plate (2) or the second plate (3).

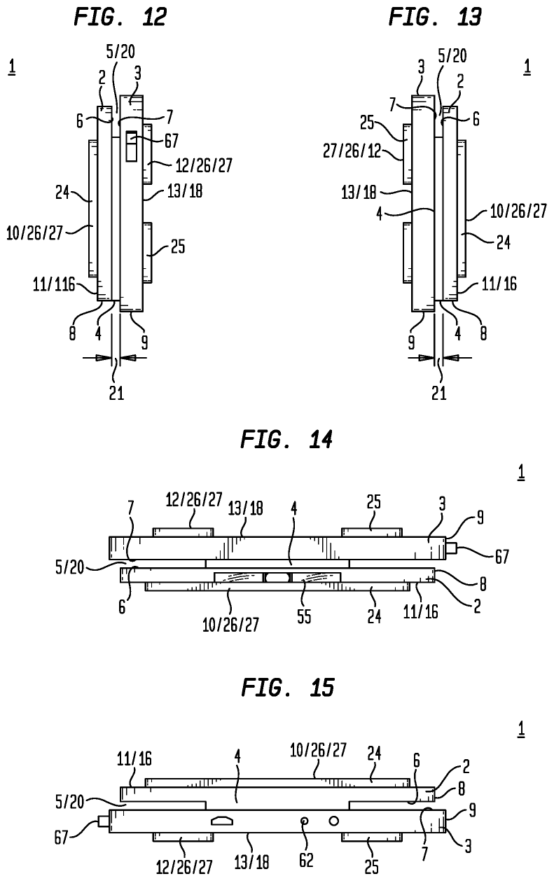

Now, with primary reference to FIGS. 6 and 12, particular embodiments of the audio system (40) can further include a switch (67). The switch (67) can be operable to control the flow of electricity from the power source (66) to the audio processing circuit (59).

Again, with primary reference to FIG. 1, particular embodiments of the audio system (40) can further include a client computing device (68). The client computing device (68) can be paired to embodiments of the audio system (40). In particular embodiments, the audio system (40) can include a first electronic data exchanger (69). The first electronic data exchanger (69) can be communicatively coupled to the processor (56). The first electronic data exchanger (69) can be controlled by the audio processing program (58). The audio processing program (58) can be executable to operate the first electronic data exchanger (69) to transmit pairing information (70) from the audio generator (1), receive digitized audio data (60), and transfer the digitized audio data (60) to the audio processing circuit (59). In particular embodiments, the client computing device (68) can include a second electronic data exchanger (71). The second electronic data exchanger (71) can be operable to receive the pairing information (70) from the audio generator (1), pair the client computing device (68) with the audio generator (1) and transmit digitized audio data (60) to the audio generator (1). In particular embodiments, the first or second electronic data exchanger (69)(71), or both, can include one or more of a BLUETOOTH® controller (72), or a WI-FI® controller (73). The client computing device (68) can be selected from the group consisting of: laptop computers, cellular telephones, tablet computers, slate computers, pad computers, personal digital assistants, smartphones, or combinations thereof.

Again, with primary reference to FIG. 1, particular embodiments of the audio system (40) can further include a server (74). The server (74) can include a server processor (75) communicatively coupled to a server non-transitory computer readable medium (76). The server (74) can be accessible by the client computing device (68) through a network (77). The network (77) can be a public network (78), such as the Internet (79), a cellular-based wireless network(s) (80), or a local network (81) (individually or collectively the “network”). In particular embodiments, the server (74) can deliver digitized audio data (60) to the client computing device (68) through the network (77).

Now, with primary reference to FIGS. 1, 2, 9 and 22, particular methods of using the audio system (40) can include one or more of engaging the first plate (2) of the audio system or a mounting plate (41) to a first acoustic resonator, or a support surface (82), securing the first plate (2) of the audio system (40) directly, or directly through the mounting plate (41) to the acoustic resonator (14), or support surface (82), and engaging the first piezoelectric layer (10) with the acoustic resonator (14). In particular embodiments, the method can further include leveling the audio system (40) in relation to horizontal. In particular embodiments, the method can further include receiving the second plate (3) of the audio system (40) in the acoustic resonator mount, and engaging a second piezoelectric layer with a second acoustic resonator (14). In particular embodiments, the method can further include pairing a client computing device (68) with the audio system (40) and transmitting digitized audio data (60) from the client computing device (68) to the audio system (40). In particular embodiments, the method can further include transmitting digitized audio data (60) from a server (74) to the client computing device (68). The method can further include processing digitized audio data (60) by executing an audio processing program (58) and generating an electric field (34) which varies in amplitude (32) or frequency (33) which drives the first or second piezoelectric layer (10)(12) at a resonance frequency (35), and transferring the resonance frequency (35) to the first or second acoustic resonators (14) to produce audio output (15).

As can be easily understood from the foregoing, the basic concepts of the present invention may be embodied in a variety of ways. The invention involves numerous and varied embodiments of a piezoelectric audio system and methods for making and using such piezoelectric audio system including the best mode.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “spacer” should be understood to encompass disclosure of the act of “spacing”—whether explicitly discussed or not—and, conversely, were there effectively disclosure of the act of “spacing”, such a disclosure should be understood to encompass disclosure of a “spacer” or even a “means for spacing.” Such alternative terms for each element or step are to be understood to be explicitly included in the description.

In addition, as to each term used, it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the piezoelectric audio systems herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. An audio system, comprising:
an audio generator, including:
a first plate;
a second plate;
a spacer interconnecting said first plate and said second plate in fixed spaced apart relation to provide an open space between first and second plate inner faces, said open space extending from said spacer to corresponding first and second plate edges;
a first piezoelectric layer coupled to a first plate outer face; and
a second piezoelectric layer coupled to a second plate outer face.

2. The audio system of claim 1, wherein said first piezoelectric layer or said second piezoelectric layer has a static dimension which varies based on amplitude and frequency of an electric field applied to said first piezoelectric layer or said second piezoelectric layer.

3. The audio system of claim 2, further comprising an acoustic resonator engaged to said first piezoelectric layer or said second piezoelectric layer, said acoustic resonator capable of converting variation in said static dimension of said first piezoelectric layer or said second piezoelectric layer into an audio output.

4. The audio system of claim 1, wherein said first piezoelectric layer or said second piezoelectric layer comprises only one first piezoelectric layer or only one second piezoelectric layer.

5. The audio system of claim 4, wherein said only one first or second piezoelectric layer continuously extends over the first or second outer plate to a first or second piezoelectric layer periphery disposed proximate said first or second plate edge.

6. The audio system of claim 1, wherein said first piezoelectric layer or said second piezoelectric layer comprises a plurality of first piezoelectric layers or a plurality of second piezoelectric layers.

7. The audio system of claim 1, wherein said first piezoelectric layer comprises only one piezoelectric layer, and wherein said second piezoelectric layer comprises a plurality of second piezoelectric layers.

8. The system of claim 1, further comprising a mounting plate having a mounting plate first side opposite a mounting plate second side, said mounting plate first side configured to removably secure to said second plate outer surface, said mounting plate second side configured to engage an acoustic resonator, said mounting plate having a mounting plate aperture through which said second plate piezoelectric layer extends to allow contact with said acoustic resonator.

9. The system of claim 8, further comprising a securement element disposed on said mounting plate first side or said second plate outer surface to releasably secure said second plate outer surface to said mounting plate first side.

10. The system of claim 9, wherein said securement element includes a mateable fastener pair which mateably engage to releasably secure said second plate outer face to said mounting plate first side.

11. The system of claim 10, wherein said mateable fastener pair includes:
a pair of posts disposed on said mounting plate first side or said second plate outer face;
a corresponding pair of post receptacles disposed on said mounting plate first side or second plate outer face, said pair of post receptacles configured to mateably engage said pair of posts to releasably secure said second plate outer face to said mounting plate first side.

12. The system of claim 1, further comprising a level disposed on said first plate or said second plate.

13. The system of claim 1, further comprising a processor communicatively coupled to a non-transitory memory element containing an audio processing program executable to control an audio processing circuit to:
receive a digitized audio data;
convert said digitized audio data to audio amplitude and frequency data;
generate an electric field having an amplitude and frequency which varies based on said audio amplitude and frequency data;
apply said electric field having said amplitude and frequency to said to said first piezoelectric layer or said second piezoelectric layer.

14. The system of claim 13, further comprising a microphone disposed on said first plate or said second plate, said microphone communicatively coupled to said audio processing circuit, wherein said audio processing program executable to:
receive a microphone analog input from said microphone;
convert said microphone analog input to audio amplitude and frequency data;
generate an electric field having an amplitude and frequency which varies based on said audio amplitude and frequency data; and
apply said electric field having said amplitude and frequency to said first piezoelectric layer or said second piezoelectric layer.

15. The system of claim 14, further comprising a speaker disposed on said first plate or said second plate, said speaker communicatively coupled to said audio processing circuit, wherein said audio processing program executable to:
receive a digitized audio data or microphone analog output;
convert said digitized audio data or said microphone analog output to audio amplitude and frequency data;
generate an electric field having an amplitude and frequency which varies based on said audio amplitude and frequency data;
apply said electric field to said speaker to generate speaker audio output.

16. The system of claim 15, wherein said audio processing program further executable to control a first electronic data exchanger operable to:
transmit pairing information from said audio generator;
receive said digitized audio data; and
transfer said digitized audio data to said audio processing circuit.

17. The system of claim 16, further comprising a client computing device including a second electronic data exchanger operable to:
receive said pairing information from said audio generator;
pair said mobile computing device with said audio generator; and
transmit digitized audio data to said audio generator.

18. The system of claim 17, wherein said first or second electronic data exchanger further includes one or more of a BLUETOOTH® controller, or a controller.

19. The system of claim 18, wherein said client computing device is selected from the group consisting of: lap top computers, cellular telephones, tablet computers, slate computers, pad computers, personal digital assistants, smartphones, or combinations thereof.

20. The system of claim 17, further comprising a server including a server processor communicatively coupled to a server non-transitory computer readable medium, said server accessible by said client computing device through a network, server serving audio data.

21-23. (canceled)
